(19) United States
(12) Patent Application Publication
(10) Pub. No.: US 2008/0219903 A1
(43) Pub. Date: Sep. 11, 2008

(54) Device for Injecting Fluids Inside a Rotary Fluidized Bed

(76) Inventor: Axel de Broqueville, Grez-Doiceau (BE)

Correspondence Address: FINA TECHNOLOGY INC, PO BOX 674412, HOUSTON, TX, 77267-4412, US

(21) Appl. No.: 11/793,366

(22) PCT Filed: Dec. 9, 2005
(86) PCT No.: PCT/EP05/56640

§ 371 Date: Mar. 25, 2008

(30) Foreign Application Priority Data
Dec. 15, 2004 (BE) 2004/0613

(51) Int. Cl. B01J 7/00

(52) U.S. Cl. 422/306

(57) ABSTRACT

The invention concerns a device for injecting fluids inside a rotary fluidized bed wherein the fluid jets are oriented in the rotational direction of the fluidized bed and surrounded with at least one deflector delimiting around said jets a space generally convergent then divergent and upstream of said jet passages through which suspended particles in the rotary fluidized bed can penetrate so as to be mixed with the fluid jets which transfer to them part of their kinetic energy before leaving said space.

The present invention relates to a device for injecting a fluid or mixture of fluids, liquid or gaseous, into a rotating fluidized bed, for increasing the momentum and energy that the fluid can transfer to the solid particles rotating in a rotating fluidized bed in order to increase their speed of rotation.

Methods in which solid particles are in suspension in a fluid and thereby form a fluidized bed through which this fluid passes, are well known. When the fluid is injected tangentially to the cylindrical wall of a cylindrical reactor, it can transfer part of its kinetic energy to the solid particles to make them rotate, and if the energy transfered is sufficient, this rotational movement produces a centrifugal force which can maintain the fluidized bed along the cylindrical wall of the reactor, thereby forming a rotating fluidized bed, whereof the surface is approximately an inverted truncated cone, if the cylindrical reactor is vertical. Such a method is the subject of Belgian patent application No. 2004/0186, filed 14 Apr. 2004, in the name of the same inventor.

However, when a fluid jet is injected at high speed into a large reactor, it is rapidly slowed down by its expansion in the reactor, thereby limiting its ability to transfer a significant momentum to the solid particles. This is why, unless other mechanical means are used to rotate the fluidized bed, it is necessary to have a very high fluid flow rate to transfer to the solid particles the momentum necessary to maintain a sufficient speed of rotation to maintain them along the cylindrical wall of the reactor, and if the fluid density is much lower than the density of the particles, the devices for centrally removing these fluids may become very bulky.

The present invention, to improve the efficiency of transfer of momentum and kinetic energy between a fluid jet and solid particles in suspension in a rotating fluidized bed, comprises deflectors, inside the rotating fluidized bed, appropriately profiled and arranged close to the fluid injectors, for the mixing of the injected fluid with a limited quantity of solid particles, while channeling it, in order to prevent or reduce its expansion in the reactor before it has transferred a substantial quantity of its kinetic energy to the solid particles. This device is suitable for using fluids that are much lighter than the solid particles, and for injecting a fluid at high speed into the reactor without losing a large part of its kinetic energy on account of its expansion in the reactor. An application of this application is described in a Belgian patent application, in the name of the same inventor, filed on the same day as the present application.

The present invention may also apply to a horizontal reactor. In this case, the speed of injection of the fluid into the reactor, its flow rate and the efficiency of transfer of its kinetic energy, must be sufficient to impart a speed of rotation to the fluidized bed producing a sufficient centrifugal force to maintain it against the cylindrical wall of the upper part of the reactor.

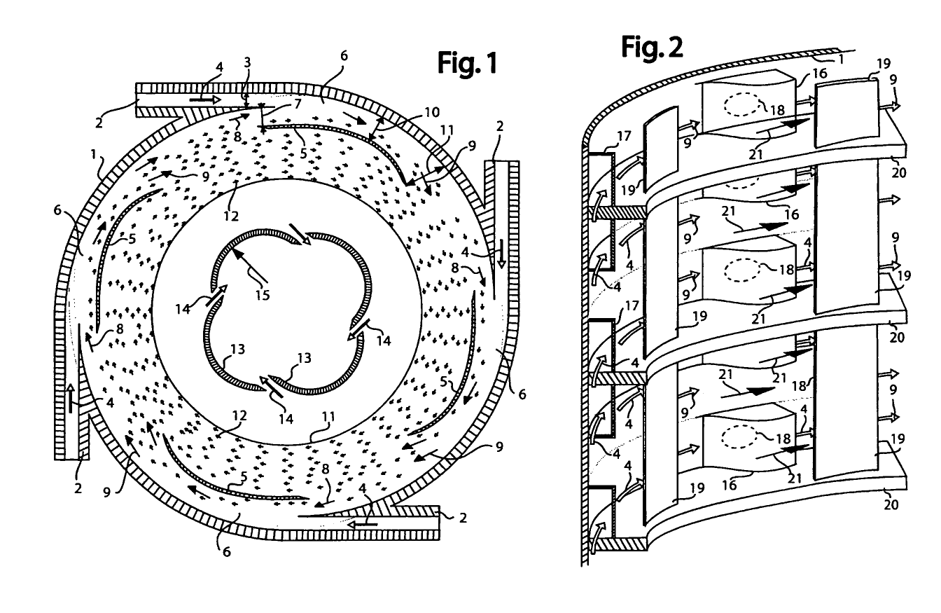

FIG. 1 shows a cross section of a reactor in order to visualize this fluid injection device. It shows the cross section (1) of the cylindrical wall of a cylindrical reactor, the cross sections (2) of the width (3) of fluid injectors (4) tangentially entering the reactor, and the cross section (5) of side deflectors, arranged longitudinally (perpendicular to the plane of the figure) at a short distance from the cylindrical wall of the reactor, opposite the injectors, in order to channel the fluid jets into the spaces (6), generally convergent then divergent, located between the deflectors and the cylindrical wall of the reactor.

These side deflectors, together with the injectors, bound access passages or corridors of width (7), through which streams (8) of solid particles in suspension in the rotating fluidized bed can enter these spaces (6) and mix with the fluid jets (4). The convergence or divergence limited by the deflectors in the first part of these spaces (6) prevents or limits the expansion of the fluid jets, whereof the pressure may decrease to preserve a substantial part of their speed while they accelerate the streams (8) of solid particles. The fluid streams (9) then slow down in the divergent part of these spaces or corridors (6) and their pressure can rise to reach the reactor pressure. Due to inertia, the solid particles slow down less and may have a tangential outlet speed close to or even higher than that of the fluids which will therefore have yielded to them a large part of their kinetic energy.

If the length of the space (6) and its minimum cross section (10) are such that the injected fluids can yield such a large part of their energy to the solid particles that their speed at the outlet of said space may decrease excessively, the injection pressure and hence their energy must increase to enable the fluids to escape via the outlet (11), despite the considerable slowdown caused by the solid particles. This pressure increase is transferred into the access passages or corridors (7) and decreases the inlet speed therein of the solid particles, whereof the concentration increases and whereof the flow rate decreases, accordingly decreasing the quantity of energy that they can absorb, in order to obtain an equilibrium of energy transfer depending on the dimensions of these spaces (6), and the speeds and densities of the solid particles and of the fluids. To avoid this slowdown of the solid particles in the access passages or corridors (7), the length of these spaces (6) must be shorter insofar as the ratios of the width (3) or cross section of the injectors to the width (7) or cross section of the access passages are low, so that the fluids still have a speed substantially higher than that of the particles at the outlet (11). In contrast, the quantity of energy transferred to the solid particles will be greater if these ratios of cross sections are lower and if the length of these spaces (6) is higher, the optimum depending on the operating conditions and objectives.

Simplified calculations show that these dimensions allow for wide variations in the operating conditions enabling the fluids to yield at least three-quarters of their kinetic energy, in order to obtain a sufficient transfer of momentum to the solid particles by very light fluids, without excessively increasing their flow rate, by injecting these fluids at high speed.

The figure also shows the cross section (11) of the surface of the rotating fluidized bed, the solid particles symbolized by small arrows (12) indicating their travel direction, the cross section of central deflectors (13), bounding longitudinal slits for centrally sucking out the fluids (14) to remove them from the reactor, the curvature (15) of these central deflectors ensuring the separation between the solid particles and the fluid before its removal.

FIG. 2 shows an axonometric projection of part of the side wall (1) of a reactor, for better visualization of the fluid injection devices. It shows injectors, indicated at (16), or their longitudinal cross section (17) and, in dotted lines, the cross section (18) of the tubes feeding these injectors, through the reactor wall, with fluids of which the streams are symbolized by the arrows (4), leaving the injectors and passing between the side wall (1) of the reactor and the side deflectors (19).

The injectors are separated by transversal rings or fractions of rings (20) running along the side wall (1) of the reactor and the side deflectors (19) are inserted between these rings, leaving an access corridor for the streams of solid particles, symbolized by the black arrows (21). These rings or fractions of rings may be transversal fins or helical turns oriented in order to make the solid particles rise along the side wall of the reactor. They may also be hollow and serve as a fluid distributor to the injectors connected thereto.

### EXAMPLE

The transfers of energy and momentum between fluids and solid particles strongly depend on the type and size of the particles. However, simplified calculations show, as an indicative example, that for solid particles with a density 700 times higher than the fluid density, with a ratio of the cross section of the access corridors (7) to the injectors of 3 to 4 and an outlet (11) cross section equal to or greater than the sum of the cross sections of the access corridors and the injectors, the fluids can be injected at a speed 5 to 15 times higher than the average speed of rotation of the solid particles, and transfer at least 75% of their kinetic energy to said particles, if the space (5) is sufficiently long with regard to the size of the particles.

I claim:

1-9. (canceled)

10. A device for injecting a fluid into a rotating fluidized bed that moves along a fixed cylindrical wall, comprising:
at least one fluid injector for injecting a fluid tangentially to said cylindrical wall, said fluid rotating along said cylindrical wall and causing said rotating fluidized bed to rotate before being removed;
said device further being comprised of at least one longitudinal side deflector bounding said rotating fluidized bed and a space between said cylindrical wall and said deflector around said fluid injector, and an access passage or corridor for a stream of solid particles in suspension in said rotating fluidized bed that issues upstream of said injector and enters said bounded space to be mixed therein with a fluid jet issuing from said injector; and
wherein said bounded space is sufficiently long for said fluid jet to yield a substantial part of a kinetic energy to said solid particles before reaching an outlet of said space.

11. The injection device of claim 10, wherein said space bounded by said deflector and surrounding said fluid jet is first convergent then divergent.

12. The injection device of claim 10, wherein a cross section of said fluid injector is elongated so as to inject said fluid in a form of a thin film along a cylindrical wall of a reactor containing said rotating fluidized bed, and wherein said deflector has a shape of a fin that bounds said space through which said thin film of said fluid passes within said cylindrical wall of said reactor.

13. The injection device of claim 11, wherein a cross section of said fluid injector is elongated so as to inject said fluid in a form of a thin film along a cylindrical wall of a reactor containing said rotating fluidized bed, and wherein said deflector has a shape of a fin that bounds said space through which said thin film of said fluid passes within said cylindrical wall of said reactor.

14. The injection device of claim 10, wherein said space is at least twice as narrow as an average thickness of said rotating fluidized bed.

15. The injection device of claim 12, wherein said space is at least twice as narrow as an average thickness of said rotating fluidized bed.

16. The injection device of claim 10, wherein the injection device comprises transversal rings or fractions of rings fixed along said cylindrical wall and bounds said space through which said fluid jet passes within said deflector and said cylindrical wall.

17. The injection device of claim 10, further comprised of transversal fins fixed along said cylindrical wall and said deflector and inclined to the central axis of said cylindrical wall in order to longitudinally deflect said solid particles passing through said passage.

18. The injection device of claim 12, further comprised of transversal fins fixed along said cylindrical wall and said deflector and inclined to the central axis of said cylindrical wall in order to longitudinally deflect said solid particles passing through said passage.

19. The injection device of claim 13, further comprised of transversal fins fixed along said cylindrical wall and said deflector and inclined to the central axis of said cylindrical wall in order to longitudinally deflect said solid particles passing through said passage.

20. The injection device of claim 16, wherein said rings or fractions of rings have helical turns oriented to make said solid particles in suspension rise in said rotating fluidized bed along said cylindrical wall.

21. The injection device of claim 10, wherein a cross section of said access passage or corridor is larger than a cross section of said injector.

22. The injection device of claim 20, wherein a cross section of said outlet of said space is equal to or larger than a sum of a cross section of said injector and of said access passage or corridor.

23. A fixed circular reaction chamber containing the injection device of claim 10.

24. The reaction chamber of claim 23, wherein said injected fluid is removed from a central inner location of said reactor.
